(19) United States
(12) Patent Application Publication
(10) Pub. No.: US 2012/0106868 A1
(43) Pub. Date: May 3, 2012

(54) APPARATUS AND METHOD FOR IMAGE CORRECTION

(75) Inventor: Shih-Chin Lin, Hsinchu County (TW)

(73) Assignee: MStar Semiconductor, Inc., Hsinchu County (TW)

(21) Appl. No.: 13/286,300

(22) Filed: Nov. 1, 2011

(30) Foreign Application Priority Data
Nov. 1, 2010 (TW) 099137545

(51) Int. Cl. G06K 9/40

(52) U.S. Cl. 382/275

(57) ABSTRACT

An image correction apparatus for correcting an original image captured by a photographing device is provided. The image correction apparatus includes a storage and a texture mapping module. The storage therein stores mapping data sets associated with the photographing device. The invention is able to construct and utilize mapping data associated with a particular optical lens when used as part of the photographic device. The texture mapping module corrects an original captured image using a texture mapping procedure according to the appropriate mapping data to generate a corrected image. The texture mapping procedure may use mapping data in a polygon based approach to generate corrected images more efficiently.

### PRIORITY

This application claims the benefit of Taiwan application Serial No. 99137545, filed Nov. 1, 2010, the subject matter of which is incorporated herein by reference.

### BACKGROUND OF THE INVENTION

1. Field of the Invention

The invention relates in general to image processing, and more particularly to automated image processing for correcting a deformed image by a digital apparatus.

2. Description of the Related Art

Accompanied by the maturing of various consumer electronic products, it is now common that an automobile be provided with a small-size monitor visible to passangers in front seats of the automobile. The small-sized monitor mainly displays video, control images of a multimedia system, and maps provided by a navigation system. Further, certain monitors cooperating with photographing devices installed at a front end or a rear end of an automobile are capable of displaying real-time images outside the vehicle to assist a user in better ascertaining and controlling situations in the proximity of the vehicle.

To maximize a viewable reference range for a driver, the above automobile is generally equipped with a wide-angle lens. However, when a distance between a captured object and a photographing device is not great enough, edges of the captured image by the wide-angle lens are compromised by pillow or barrel deformation. More specifically, certain differences resulting from size proportion and distance to shape determinations do exist between the resulting/displayed image and the actual object—these differences may lead to driver misjudgment of current situations, possibly leading to accidents.

To attend to the above issue of deformation in captured images, a solution associated with the prior art is provided for digitally correcting the deformed captured images by implementing an image processing chip comprising a 2-dimensional engine logically situated between a photographing device and a display device. The image processing chip, in real-time, analyzes deformation of each captured image, and performs restoration algorithms to generate a corrected image. Yet, in addition to imposing a higher load on the image processing chip due to resources required for performing the algorithms for rendering the corrected image impose, image processing chips capable of such complex and real-time algorithms are also significantly more costly.

### SUMMARY OF THE INVENTION

The invention is directed to a method and apparatus for image correction. Using a texture mapping procedure and predetermined mapping data associated with the photographing device, deformation resulting from an optical lens in a photographing device is effectively corrected. The method and apparatus according to the present invention is applicable to not only automobiles equipped with external image monitoring systems, but also other photographing systems which suffer from image deformation complications.

According to the present invention, an apparatus for image correction for correcting an original image captured by a photographing device is provided. The apparatus for image correction comprises a storage and a texture mapping module. The storage stores mapping data associated with an image deformation resulting from an optical lens of the photographing device. The texture mapping module corrects the original image via a texture mapping procedure according to the mapping data to generate a corrected image.

According to the present invention, a method for image correction is further provided. The method comprises steps of receiving an original image captured by a photographing device, and correcting the original image according to mapping data associated with an image deformation resulted from an optical lens of the photographing device using a texture mapping procedure to generate a corrected image.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a flowchart of a method for image correction according to an embodiment of the present invention.

FIG. 2A is an example of a predetermined object with a known pattern; FIG. 2B is an example of a corresponding captured result of FIG. 2A; and FIG. 2C is an example comprising a plurality of triangular mesh patterns.

FIG. 3A is an example of an original image; FIG. 3B is an example of a reference image; FIG. 3C is an example of a corrected image.

FIG. 3D is an example of a mesh pattern; FIG. 3E is an example of an original image; FIG. 3F is an example of a corrected image.

FIG. 4 is a flowchart of a texture mapping procedure according to an embodiment of the present invention.

FIG. 5 is a block diagram of an apparatus for image correction according to the present invention.

FIG. 6 is a detailed block diagram of the apparatus for image correction.

### DETAILED DESCRIPTION OF THE INVENTION

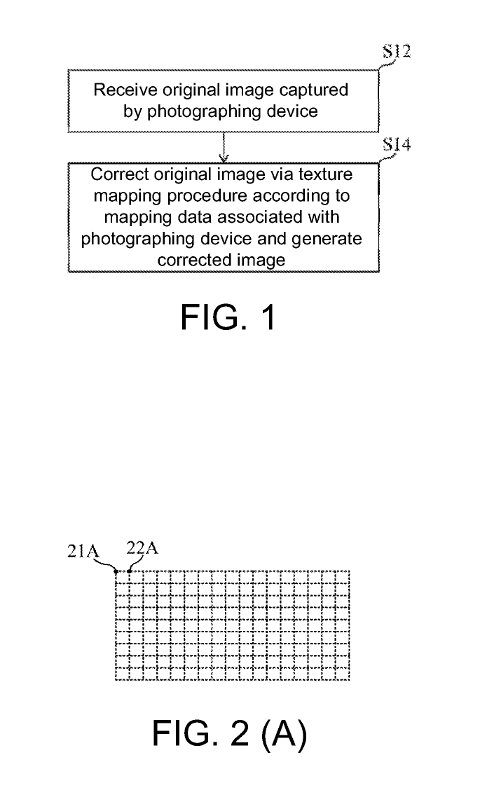

FIG. 1 shows a flowchart of a method for image correction according to an embodiment of the present invention. For example, a photographing device for capturing situations of proximity outside the automobile is installed to a front end or a rear end of an equipped automobile. In this embodiment, mapping data associated with the photographing device is predetermined and is stored in the hardware performing the method. The method begins with Step S12 when the hardware receives an original image captured by the photographing device. In Step S14, the original image is corrected according to the mapping data using a defined texture mapping procedure to generate a corrected image.

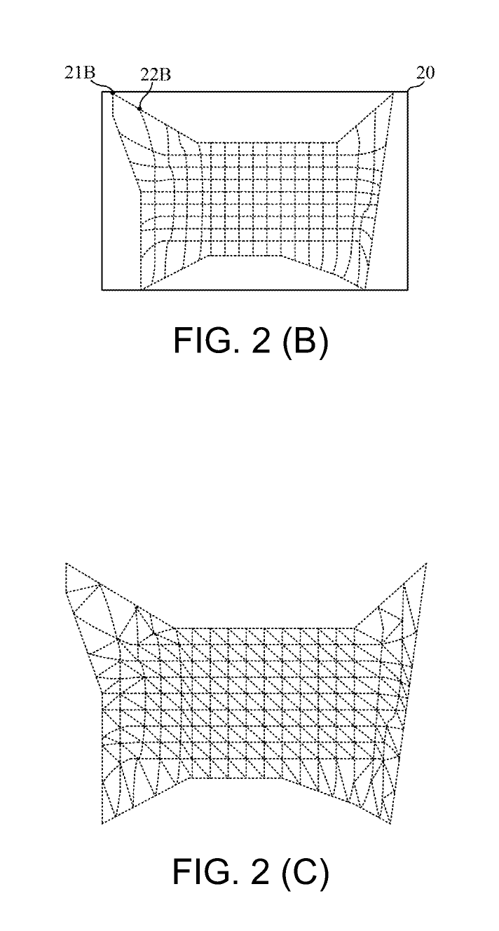

The mapping data may be designed as to associate with image deformation caused by an optical lens of the photographing device, and is applied to compensate and/or restore image distortion caused by the optical lens. For example, an object with a predetermined pattern is first photographed by the photographing device, and a captured image is compared with the actual object to identify differences between the two to further determine the mapping data. FIG. 2A shows a rectangular meshed object as an example of the predetermined patterned object; FIG. 2B shows a solid-line rectangle 20 with dotted lines therein as an example of a captured image. Being affected by the optical lens or other undesired characteristics of the photographing device, edges of the captured image are often deformed as shown in FIG. 2B; that is, lines that are originally straight in the actual object appear as irregularly twisted, stretched, or compressed in the captured image.

The mapping data adopted in Step S14 comprises a corresponding mapping relationship between the original image and the corrected image. The mapping relationship may be a corresponding relationship between coordinates, or a mathematical model describing the corresponding relationship between an actual arbitrary object and its captured image. For example, suppose the image 20 comprises the mesh pattern in dotted lines that form a plurality of differently shaped quadrilaterals each corresponding to a given quadrilateral in the corrected image. When lengths and relative distances of the lines in FIG. 2A are known, the mapping relationship between the two images respectively represented by FIGS. 2A and 2B can be determined by utilizing a label scale or coordinates. In this embodiment, a coordinate 21A in FIG. 2A maps to a coordinate 21B in FIG. 2B and a coordinate 22A in FIG. 2A maps to a coordinate 22B in FIG. 2B. Accordingly, the mapping data comprises such mapping relationships between nodes of a mesh pattern of the original image and nodes of a mesh pattern of the corrected image.

In practice, the mesh pattern corresponding to the original image and the mesh pattern corresponding to the corrected image respectively comprise a plurality of N-angle shapes, where N is a positive integer greater than 2, e.g., 3. FIG. 2C shows an example of a plurality of triangular mesh patterns. It is to be noted that, mapping data of different photographing devices may vary. More specifically, different mapping data is adopted for different photographing devices, that is, different mapping relationships between mesh patterns of original images and mesh patterns of corrected images are adopted to achieve optimal correction results. According to the mapping data, a corrected image is generated from a captured image (e.g., FIG. 2B) using a texture mapping procedure, so that the corrected image better approximates the original image shown in FIG. 2A.

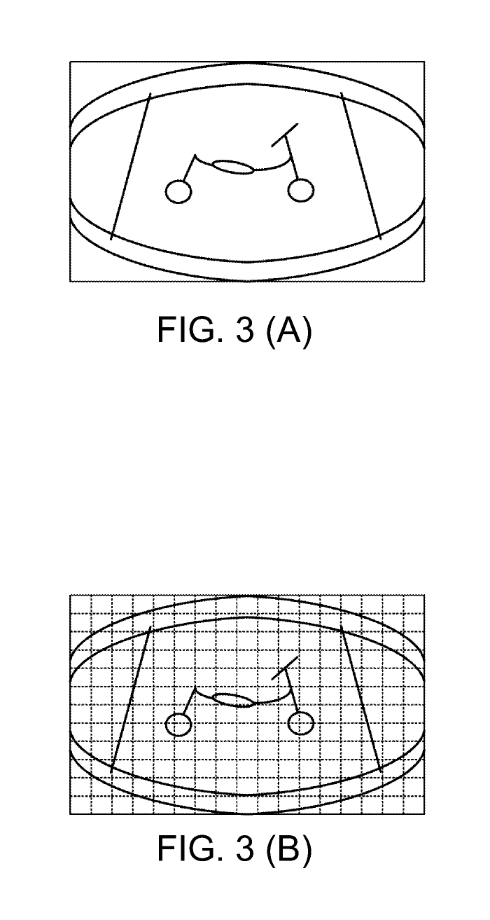

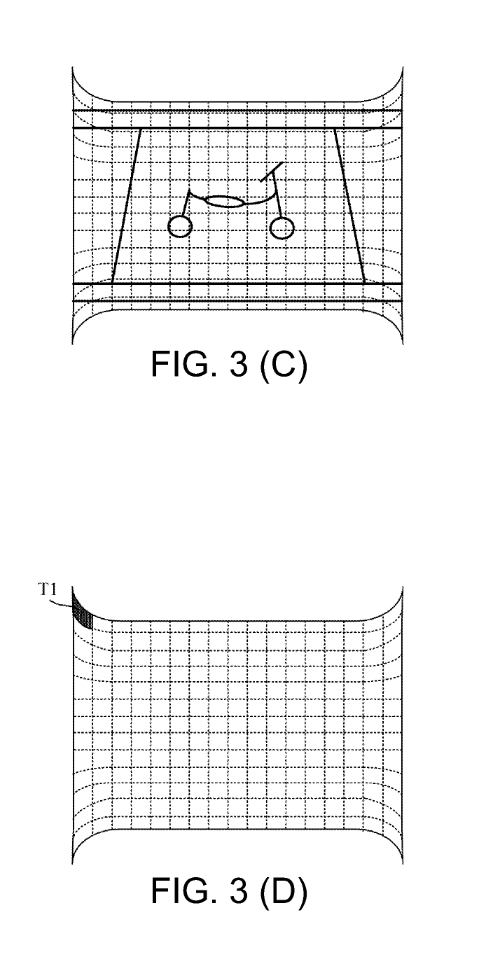

According to another embodiment of the present invention, any image or object is first photographed as an original image, which comprises image deformation caused by an optical lens of the photographing device. Referring to FIG. 3B, the original image is marked with virtual grid lines to form a reference image. By judging with naked eye and experience, appropriate stretching or compression on the reference image is determined to eliminate the image deformation as closely as possible. FIG. 3C shows an example after stretching/compression of the reference image. Referring to FIG. 3C, apart from content of the original image, the virtual grid lines are also stretched/compressed. By comparing grid lines in FIG. 3B with those in FIG. 3C, the mapping data adopted in Step S14 can be identified; that is, the mapping relationship between the original image and the corrected image can be determined for subsequent storage and use with other captured images using the disclosed invention. In this embodiment, the original image shown in FIG. 3A is corrected by stretching its four corners, or relatively compressing its upper and lower sides. In practice, the mapping data adopted in Step S14 is the mapping relationship between the stretched/compressed virtual grid lines in FIG. 3C and the virtual grid lines of the original image in FIG. 3B. In other embodiments, image analysis may also be first performed on deformation of an original image to obtain appropriate mapping data to further eliminate image deformation.

Having established the mapping data, images captured by the photographing device can be corrected via the texture mapping procedure according to the mapping data to generate corrected images. More specifically, for a predetermined photographing device, reference mapping data is first established for all future procedures rather than re-identifying a deformation pattern and a corresponding correction procedure each time an image is captured.

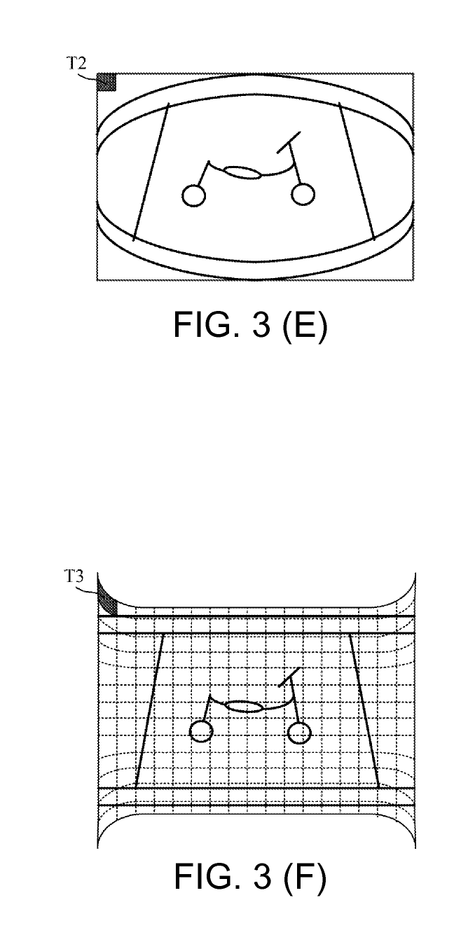

Taking the mesh pattern indicated by dotted grid lines in FIG. 3D as an example, the texture mapping procedure in Step S14 may comprise steps shown in FIG. 4. In Step S14A, a target N-angle shape from a plurality of N-angle shapes in the mesh pattern is selected, e.g., a target quadrilateral T1 in FIG. 3D is selected. In Step S14B, according to the mapping relationship corresponding to the mesh pattern from the mapping data, an original N-angle shape corresponding to the target N-angle shape is identified, e.g., an original quadrilateral T2 in FIG. 3E is identified. In Step S14C, the original N-angle shape is processed by a texture mapping procedure to form an N-angle area of the corrected image, e.g., a quadrilateral area T3 in FIG. 3F is formed. More specifically, the quadrilateral area T3 is an image block restored from deformation to be more approximate to a true image of the captured image. To display the corrected image on a display device, four irregular corners of the corrected image are trimmed, so that a final corrected image displayed on the display device includes only a rectangular region at a central part of FIG. 3F.

A mapping relationship generally exists between a photographed result (i.e., the original image) of the photographing device and the corrected image. As described, the mapping data comprises the mapping relationship between the two. Corresponding relationships between the four vertices of the target quadrilateral T1 and those of the original image are predetermined; for example, the four vertices of the target quadrilateral T1 are designed to be corresponding to four predetermined coordinates in the original image. With the corresponding relationships, Step S14B may identify a range covered by the original quadrilateral T2 in the original image according to the predetermined coordinates.

In practice, each of the four vertices of the original quadrilateral T2 may respectively be a pixel that corresponds to a set of original image data. After identifying the original quadrilateral T2, Step S14C may determine corrected image data of a quadrilateral area T3 according to the four sets of image data. For example, supposing the quadrilateral area T3 comprises M pixels (where M is a positive integer), Step S14C determines corrected image data corresponding to each pixel of the M pixels according to the original quadrilateral T2 via means such as interpolation. Alternatively, Step S14C may fill at least one image texture to the quadrilateral area T3 according to the original quadrilateral T2.

In practice, the texture mapping procedure in Step S14 may comprise determining image data of the pixels by texture filtering. Current common methods includes nearest-neighbor interpolation, bilinear interpolation, and trilinear interpolation, with the latter two being capable of reducing distortion and zigzag edges, and are extensively applied due to their effectiveness.

A three-dimensional graphic engine for handling multimedia data and/or operating in conjunction with a navigation system is a common part in an automobile. Apart from its primary functions, the three-dimensional graphic engine can also be implemented to perform the texture mapping procedure in Step S14. Again, since the texture mapping procedure is one of the fundamental functions of the three-dimensional graphic engine, any extra costs incurred by an additional image processing chip dedicated for correcting image distortion may be eliminated when the three-dimensional graphic engine is directly utilized to handle the texture image procedure. It is to be noted that, the texture mapping procedure may also be performed by other types of graphic engines instead of the three-dimensional graphic engine. In practice, capabilities of the three-dimensional graphic engine, like texture mapping, texture shading, and texture filtering, are all capable of realizing the texture mapping procedure in Step S14.

The above steps of determining the corrected image data may be iterated in sequence for each of the N-angle shapes in the mesh pattern to determine corrected image data corresponding to the N-angle shapes, so as to accordingly generate a complete corrected image, i.e., a final result of Step S14.

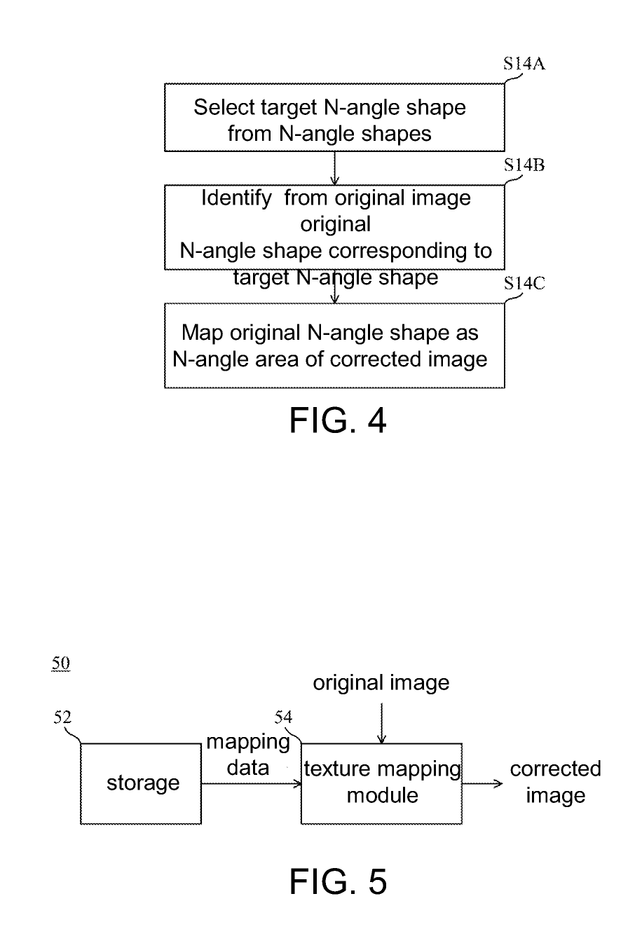

An image correction apparatus for correcting an original image captured by a photographing device is provided according to another embodiment of the present invention. Referring to FIG. 5, an image correction apparatus 50 comprises storage 52 and a texture mapping module 54. The storage 52 stores therein mapping data associated with the photographing device and/or utilized photographic lens. The mapping data is generally designed to associate with image deformation caused by an optical lens of the photographing device to compensate and/or restore image distortion resulting from the optical lens, although the mapping data may also include information which is related to other parts of the photographing device and associated image deformation characteristics. The texture mapping module 54 corrects the original image via a texture mapping procedure according to the mapping data to generate a corrected image as detailed above.

As described previously, an automobile is generally equipped with a three-dimensional graphic engine capable of performing the texture mapping procedure. In other words, the texture mapping module 54 may be an innate three-dimensional graphic engine in a system where the image correction apparatus 50 is already located—the method of co-shared hardware eliminates costs of an additional high-end image processing chip.

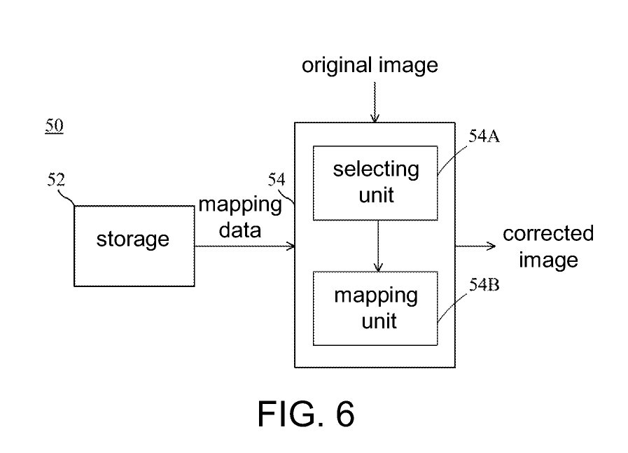

FIG. 6 shows a detailed block diagram of the image correction apparatus 50 according to an embodiment of the present invention. In this embodiment, the texture mapping module 54 comprises a selecting unit 54A and a mapping unit 54B. The selecting unit 54A is for selecting a target N-angle shape from a plurality of N-angle shapes in a mesh pattern of mapping data. The mapping unit 54B is for identifying from an original image an original N-angle shape corresponding to the target N-angle shape according to the mapping relationship in the mapping data, and mapping the original N-angle shape to an N-angle area of the corrected image.

With description of the above embodiments, the present invention provides a method and apparatus for image correction, which effectively corrects deformation resulting from an optical lens in a photographing device via a texture mapping procedure and predetermine mapping data associated with the photographing device. The method and apparatus according to the present invention is applicable to not only automobiles equipped with external image monitoring systems but also any photographing systems with image deformation complications.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for image correction, comprising steps of:
(a) receiving an original image captured by a photographing device; and
(b) correcting the original image using a texture mapping procedure according to mapping data associated with an image deformation resulting from an optical lens of the photographing device to generate a corrected image.

2. The method according to claim 1, wherein the mapping data comprises data of a plurality of N-angle shapes, where N is a positive integer greater than 2, and the texture mapping procedure comprises steps of:
(b1) selecting a target N-angle shape from the plurality of N-angle shapes;
(b2) identifying from the original image an original N-angle shape corresponding to the selected target N-angle shape; and
(b3) mapping the original N-angle shape as an N-angle area of the corrected image.

3. The method according to claim 2, wherein the positive integer is 3.

4. The method according to claim 2, wherein the target N-angle shape comprises N vertices, each vertex corresponding to a predetermined coordinate, and the step (b2) identifies the original N-angle shape according to the predetermined coordinates.

5. The method according to claim 2, wherein the original N-angle shape comprises N vertex pixels each corresponding to a set of original image data, and the step (b3) determines corrected image data of the N-angle area according to the N sets of original image data.

6. The method according to claim 2, wherein the step (b3) comprises determining an image texture to fill the N-angle area according to the original N-angle shape.

7. The method according to claim 2, wherein the N-angle area comprises M pixels, and the step (b3) determines a set of corrected image data corresponding to each of the M pixels according to the original N-angle shape, where M is a positive integer.

8. The method according to claim 1, wherein the texture mapping procedure is performed by a three-dimensional graphic engine.

9. An apparatus for image correction, for correcting an original image captured by a photographing device, the apparatus comprising:
a storage, for storing mapping data associated with an image deformation resulting from the capture of an image using the photographing device; and
a texture mapping module, for correcting the original image using a texture mapping procedure according to the mapping data to generate a corrected image.

10. The apparatus according to claim 9, wherein the mapping data is directly associated with the image deformation resulting from an optical lens of the photographing device.

11. The apparatus according to claim 10, wherein the texture mapping module is a three-dimensional graphic engine.

12. The apparatus according to claim 10, wherein the mapping data comprises data of a plurality of N-angle shapes, where N is a positive integer greater than 2, and the texture mapping module comprises:
a selecting unit, for selecting a target N-angle shape from the plurality of N-angle shapes; and
a mapping unit, for identifying from the original image an original N-angle shape corresponding to the selected target N-angle shape, and mapping the original N-angle shape as an N-angle area of the corrected image.

13. The apparatus according to claim 12, wherein the positive integer N is 3.

14. The apparatus according to claim 12, wherein the target N-angle shape comprises N vertices, each vertex corresponding to a predetermined coordinate, and the mapping unit identifies the original N-angle shape according to the predetermined coordinates.

15. The apparatus according to claim 12, wherein the original N-angle shape comprises N vertex pixels each corresponding to a set of original image data, and the mapping unit determines corrected image data of the N-angle area according to the N sets of original image data.

16. The apparatus according to claim 12, wherein the mapping unit determines an image texture to fill the N-angle area according to the original N-angle shape.

17. The apparatus according to claim 12, wherein the N-angle shape comprises M pixels, and the mapping unit determines a set of corrected image data corresponding to each of the M pixels according to the original N-angle shape, where M is a positive integer.
